(19) United States
(12) Patent Application Publication
(10) Pub. No.: US 2024/0271704 A1
(43) Pub. Date: Aug. 15, 2024

(54) BELLOWS, JOINT ARRANGEMENT AND MOTOR VEHICLE

(71) Applicant: GKN Driveline International GmbH, Lohmar (DE)

(72) Inventor: Markus Deisinger, Lohmar (DE)

(21) Appl. No.: 18/436,288

(22) Filed: Feb. 8, 2024

(30) Foreign Application Priority Data
Feb. 10, 2023 (DE) 10 2023 103 259.3

(51) Int. Cl. F16J 15/52

(52) U.S. Cl. CPC F16J 15/52

(57) ABSTRACT

A bellows for a joint arrangement extends between a first end and a second end as a hollow body along an axis and is formed by a wall which encloses the axis between the ends along a circumferential direction and forms an inner space; wherein the wall is formed at least by a plurality of pleats arranged side by side along the axis; wherein each pleat extends along the axis starting from a first smallest diameter via a first flank to a first largest diameter and via a second flank to a second smallest diameter and a flank of at least one pleat has a plurality of structures arranged distributed along the circumferential direction.

### CROSS-REFERENCE TO RELATED APPLICATIONS

This application claims priority to German Application No. DE 10 2023 103 259.3, filed on Feb. 10, 2023, which application is hereby incorporated herein by reference in its entirety.

### BACKGROUND

A bellows for a joint regularly extends between a first end and a second end as a hollow body along an axis and is formed by a wall which encloses the axis between the ends along a circumferential direction and forms an inner space. The wall is formed at least by a plurality of pleats arranged next to one another along the axis, which have diameters that change along the axis, extend transversely to the axis and are formed by the wall. In an extended state of the bellows and with a coaxial arrangement of the first end, the axis and the second end, each pleat extends along the axis starting from a first smallest diameter via a first flank to a first largest diameter and via a second flank to a second smallest diameter. In the joint arrangement described above, the pleats enable the joint to be permanently sealed even when the rotating shafts are not arranged coaxially to one another.

The pleats usually have a circular shape in an (unloaded) initial state of the bellows. The corresponding smallest or largest diameters of several pleats can become successively smaller in terms of size starting from the first end and towards the second end.

Various processes can be used to manufacture a bellows. Depending on the material (rubber, thermoplastic) of the bellows, hydroforming and/or injection molding processes are preferred. Bellows manufactured with thermoplastic material are at least predominantly produced using an internal high-pressure process, for example so-called “press blow molding”.

Bellows are subject to the following signs of wear and stress for example when used as intended:
1. fatigue due to flank contact (of the walls of the pleats), friction and load;
2. abrasion due to flank pressure (the walls of the pleats pressed against each other);
3. deposits from the surrounding area (dust, dirt, etc.)

Furthermore, bellows generate noises, especially squeaking noises, when used as intended, particularly as a result of the well-known “stick-slip effect” (in which neighboring contact surfaces are adhesively bonded together for a short time and only then detach).

Particularly under cold start conditions, i.e. when the bellows is set in motion again for the first time after a long period of rest, such high loads can occur that the bellows fails, i.e. the wall tears open. In this case, the lubricant regularly arranged inside the bellows appears to hinder a pre-determined movement of the pleats (i.e. the opening and positioning of the pleats against each other resulting from a rotation of ends of the bellows that are not arranged coaxially to each other). For example, the opening of the pleats is hindered by an adhesive effect of the lubricant in contact with the pleats. The known pleats or flanks have flat surfaces that lie against each other over a large area, so that the adhesive effect is increased.

A bellows is known from U.S. Pat. No. 5,098,344 A, in which rib-like structures are arranged on the flanks of the pleats. The ribs of opposing flanks interlock with each other. These structures are intended to reduce a sliding movement of the flanks lying against each other and enable the transmission of torsional forces between the pleats, so that wear and stress on the pleats are reduced.

A bellows is known from US 2004/0232630 A1, whereby at least one flank of a pleat has a large number of elevated or depressed areas. This is intended to reduce the contact surfaces between opposing flanks to point contacts and to minimize the noise that arises when the flanks are wet.

### SUMMARY

Disclosed herein is a bellows that is advantageously designed to withstand cold start conditions. The disclosure includes a bellows for a joint arrangement, a joint arrangement, and a motor vehicle.

The joint arrangement comprises, for example, a (constant velocity) joint. Two shafts can be pivotably connected to one another via the joint arrangement. Such a (constant velocity) joint regularly comprises an outer joint part, an inner joint part and rolling bodies arranged between them (e.g. balls in the case of constant velocity ball joints or rolling elements in the case of tripod joints). The bellows serve to seal or protect the joint from the joint's surroundings. The bellows extends, for example, from the outer joint part to a shaft connected to the inner joint part, with a first (large) end of the bellows being attached to the outer joint part and a second (small) end to the shaft. A retaining ring, for example, is used to attach the bellows to the outer joint part (as well as to the shaft).

A bellows described herein for a joint arrangement extends between a first end and a second end as a hollow body along an axis and is formed by a wall which encloses the axis between the ends along a circumferential direction and forms an inner space. The wall is formed by at least a plurality of pleats arranged side by side along the axis. Each pleat extends along the axis from a first smallest diameter via a first flank to a first largest diameter and via a second flank to a second smallest diameter.

In particular, in at least one pleat (or in a plurality of pleats or even in all pleats), a flank of the respective pleat has a plurality of structures distributed along the circumferential direction, each structure being formed by an elevation enlarging the inner space or by a depression reducing the inner space.

For example, the pleats and structures are designed or configured in such a way that when the pleats are adjacent to one another, the structures are elastically deformable, thereby increasing a contact surface, present in the inner space, between the flanks of the pleats.

The term “elevation” and “depression” each refers to a deviation from a flat shape of a surface of the respective flank. The flanks extend for example between the respective smallest diameter and the largest diameter and along the circumferential direction around the axis and—apart from the structures—have a flat surface or a surface with a flat shape. The structure is distinguished for example by a non-continuous transition of the surface from the flat surface.

For example, the wall has a constant wall thickness at least in the area of the structures and/or in the area of the flanks, so that, for example, the elevation enlarging the inner space forms a depression on the side of the flank facing the inner space. Conversely, the depression that reduces the inner space forms an elevation on the side of the flank facing the inner space.

For example, a maximum deviation of the elevation or depression from an imaginary flat surface is at least 10%, or at least 20%, of the wall thickness of the flank in this area. For example, the maximum deviation of the elevation or depression from an imaginary flat surface is at most 50%, or at most 30%, or at most 25%, of the wall thickness of the flank in this area.

It has been observed in tests that when the ends are not arranged coaxially and the bellows are warm, most of the lubricant present in the interior is pressed out of the pleat (on the side of the axis on which the pleats are pressed together and the usually flat flanks contact each other and form contact surfaces) when the rotation of the bellows has ended.

The very thin film of lubricant remaining between the compressed flanks acts like an adhesive. For example, it compensates for the surface discontinuities (non-flat surfaces) of the flanks and thus causes strong adhesion effects between the pressed-together pleats. The known pleats with flat flank surfaces have particularly large contact surfaces. The adhesion effects are particularly present at cold ambient temperatures (and for example under cold start conditions), especially when the lubricant is in a frozen state.

With the subsequent start of rotation of the bellows (especially with frozen lubricant), the flanks are forced to separate against the adhesion resistance of the adhesion effect described above (and thus open the pleat). The delayed opening of the bonded or adhesively bonded areas of the pleats creates additional stress on other areas, which in turn may fail.

It is proposed that the shape of the flanks be modified or executed in such a way that all the required properties of the usual function are retained. However, structures are added which interrupt the large, continuous contact surfaces (in the case of flat surfaces of pleats). The structures are designed or configured in such a way that they deform elastically (back to a flat shape) when the flanks are pressed together. This behavior (i.e. the shape and elastic deformation when pressed together) facilitates the opening or separation of the flanks forming the contact surfaces in at least two ways:
1. When the flanks are pressed together, the lubricant present between the flanks is displaced at least from the area of the structures because the surface pressure is locally higher there. The contact surface, which transmits the adhesive forces between the pleats or the flanks, is reduced by the structures (i.e. the elevation or depression). This reduces the overall adhesion and makes it easier to separate the flanks or open the pleats.
2. The elastic energy stored in the flattening deformation of the structures generates forces that support the separation of the flanks or the opening of the pleats.

For example, therefore, no structures are provided which interlock when the pleats are pressed together (as proposed, for example, in U.S. Pat. No. 5,098,344 A) or which are not designed to be elastically deformable (as proposed, for example, in US 2004/0232630 A1).

The ends of the bellows are for example hollow cylindrical and are each aligned coaxially with the axis, so that the bellows can be arranged on a shaft or on a joint part via the respective end.

The axis extends in a straight line and can, for example, also be at least partially curved. For example, the axis is curved or inclined when the bellows is installed (e.g. in a joint arrangement) because the ends of the bellows are usually attached to components that are not coaxial with each other.

Apart from the open end faces at the ends, the wall is particularly closed, so that the bellows form an otherwise completely enclosed hollow body.

For example, the bellows has a plurality of pleats arranged next to each other along the axis. For example, a diameter of the respective pleat extending transversely to the axis and enclosed or formed by the wall changes essentially continuously along the axis. For example, the bellows is rotationally symmetrical (especially apart from the structures).

Each pleat extends along the axis from a first smallest diameter via a first flank to a first largest diameter and via a second flank to a second smallest diameter. The first largest diameter is therefore arranged between these smallest diameters.

In the case of two pleats arranged adjacent to each other along the axis, the second smallest diameter of a first pleat for example forms the first smallest diameter of a second pleat. The smallest diameters and largest diameters are therefore arranged alternately along the axis.

In an extended (initial) state of the bellows, the smallest and largest diameters extend parallel to each other. For example, the smallest and largest diameters and the ends are then arranged coaxially to each other.

In a side view of the bellows (for example in a sectional view, in the plane of which the axis runs), i.e. in a view transverse to the axis, a zigzag or sawtooth-like course of the wall of the bellows results. Along the zig-zag or sawtooth-like course, the smallest diameters for example form the local minima of the course of the wall and the largest diameters form the local maxima.

For example, with two pleats arranged adjacent to each other along the axis, only one of the two opposing flanks has the structures. For example, this allows the structures to be supported on the flat flank of the other pleat when the pleats are pressed together, thus enabling them to deform back.

Alternatively, in the case of two pleats arranged adjacent to each other along the axis, the opposing flanks each have elevations (i.e. structures that enlarge the inner space). For example, this also allows the structures to be supported on the flat flank or on the elevation of the other pleat when the pleats are pressed together, thereby allowing them to deform back.

Alternatively, the opposing flanks of a pleat each have depressions (i.e. structures that reduce the inner space). For example, this also enables the structures of one flank to be supported on the flank just formed or on the depression of the other flank when the pleats are pressed together, thereby allowing them to deform back.

For example, the respective structure extends in a radial direction transverse to the axis over a height, whereby the following applies:

height/[(largest diameter−smallest diameter)/2]≥0.6

For example, this ratio, i.e. the term

height/[(largest diameter−smallest diameter)/2]
is at least 0.7 or even at least 0.8. For example, this ratio is less than 0.95 because the structure
is arranged for example outside the respective reversal area (i.e. outside the transition between two adjacent flanks).

The structures therefore extend over a larger part of the respective flank, so that the largest possible elastically deformable areas and thus the smallest possible flat contact surfaces are present.

For example, between the structures and along the circumferential direction, the flank has a flat surface.

For example, the structures on the flank each have a round or curved (circular, elliptical, etc.) shape. However, other shapes, e.g. angular shapes, can also be provided.

For example, the round or curved shape is an elliptical shape whose largest shape diameter extends at least in the radial direction. For example, the smallest shape diameter extends in the circumferential direction.

For example, all structures arranged on a flank are designed or configured either as an elevation or as a depression.

For example, the structures arranged on a flank are designed or configured alternately as an elevation and as a depression along the circumferential direction.

For example, the diameters of the pleats decrease successively starting from the first end and towards the second end.

For example, the structures are arranged exclusively on the flanks of the pleats pointing towards the second end.

For example, all pleats of the bellows have the structures.

A joint arrangement is further proposed, at least comprising the described bellows and a joint, at least comprising an outer joint part with a cavity, an inner joint part and a plurality of rolling bodies, which are arranged between the outer joint part and the inner joint part. The inner joint part is pivotably arranged in the cavity. The folding bellows encloses the cavity with respect to a surrounding area of the joint. For example, the joint arrangement also comprises a shaft that can be connected or is connected to the inner joint part.

The bellows serves for example to seal or protect the joint from the surrounding area of the joint. The bellows extends, for example, from the outer joint part to a shaft connected to the inner joint part, with a first (large) end of the bellows being attached to the outer joint part and a second (small) end being attached to the shaft. A retaining ring, for example, is used to attach the bellows to the outer joint part (as well as to the shaft).

A motor vehicle is further proposed, comprising at least one drive unit and at least one wheel drivable by the drive unit as well as the described bellows or the described joint arrangement.

For example, a torque generated by the drive unit is transmitted to the wheel via the joint arrangement. However, the wheel can also be arranged as a non-driven wheel on the motor vehicle.

The bellows can be attached to a component of the motor vehicle, for example to an outer joint part of a joint, and extend to an attachment on a shaft that is connected to an inner joint part of the joint.

The explanations relating to the bellows are applicable to the joint arrangement and the motor vehicle and vice versa.

The use of indefinite articles (“an”, “a”), in particular in the patent claims and the description reproducing them, is to be understood as such and not as a number word. Accordingly, terms or components introduced thereby are to be understood as being present at least once and, in particular, as being present more than once.

As a precautionary measure, it should be noted that the number words used here (“first”, “second”, . . . ) are primarily (only) used to distinguish between several similar objects, quantities or processes, i.e. in particular they do not necessarily specify any dependency and/or sequence of these objects, quantities or processes in relation to one another. If a dependency and/or sequence is required, this is explicitly stated here or is obvious to the person skilled in the art when studying the specific embodiment described. Insofar as a component may occur more than once (“at least one”), the description of one of these components may apply equally to all or some of the plurality of these components, but this is not mandatory.

### BRIEF SUMMARY OF THE DRAWINGS

The invention and the technical context are explained in more detail below with reference to the accompanying figures. It should be noted that the invention is not intended to be limited by the embodiments given. In particular, it should be noted that the figures and in particular the proportions shown are only schematic. The figures show:

FIG. 1: a motor vehicle with an joint arrangement in a side view in section;

FIG. 2: a joint arrangement in an articulated first state;

FIG. 3: the joint arrangement according to FIG. 2 in an extended state;

FIG. 4: the joint arrangement according to FIGS. 2 and 3 in an articulated second state;

FIG. 5: a bellows in a first perspective view;

FIG. 6: the bellows according to FIG. 5 in a second perspective view;

FIG. 7: the bellows according to FIGS. 5 and 6 in a view along the axis;

FIG. 8: a first detail of the bellows according to FIGS. 5 to 7;

FIG. 9: a second detail of the bellows according to FIGS. 5 to 7;

FIG. 10: a third detail of the bellows according to FIGS. 5 to 7.

### DESCRIPTION

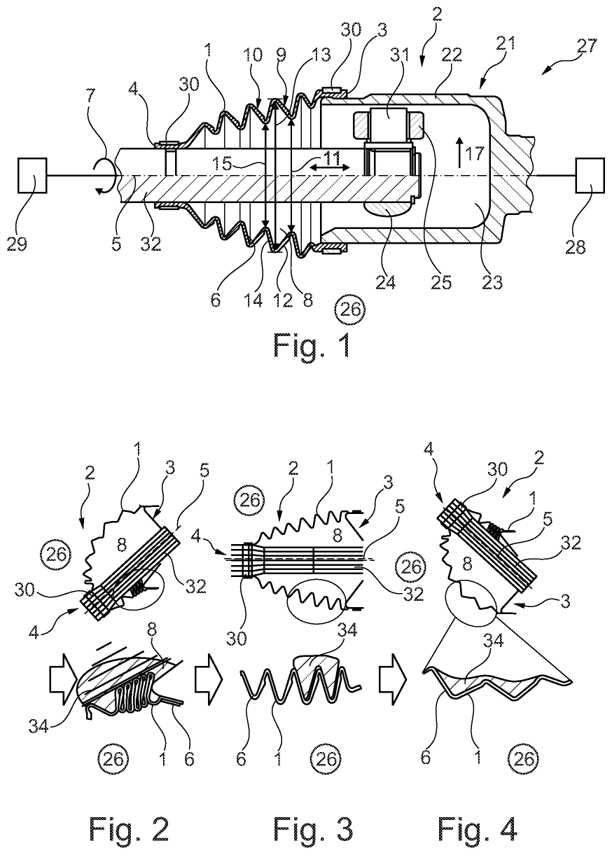

FIG. 1 shows a sectional side view of a motor vehicle 27 with an articulated joint arrangement 2. The motor vehicle 27 has a drive unit 28 and a wheel 29 that can be driven by the drive unit 28, as well as a joint arrangement 2.

The joint arrangement 2 comprises a bellows 1 and a joint 21. The joint 21 is a basically known tripod joint. The joint 21 can of course also be a basically known ball constant velocity joint.

The joint 21 comprises an outer joint part 22 with a cavity 23, an inner joint part 24 (with a plurality of trunnions 31) and a plurality of rolling bodies 25 (arranged on the trunnions 31), which are arranged between the outer joint part 22 and the inner joint part 24. The inner joint part 24 is pivotably arranged in the cavity 23. The bellows 1 encloses the cavity 23 with respect to a surrounding area 26 of the joint 21. The joint arrangement 2 also comprises a shaft 32, which is connected to the inner joint part 24. The wheel 29 is connected to the joint 21 via the shaft 32.

The bellows 1 serves to seal or protect the joint 21 against the surrounding area 26 of the joint 21. The bellows 1 extends from the outer joint part 22 to the shaft 32 connected to the inner joint part 24, wherein the bellows 1 is attached with a large first end 3 to the outer joint part 22 and with a small second end 4 to the shaft 32. A retaining ring 30 is provided for fastening the bellows 1 to the outer joint part 22 and to the shaft 32.

The bellows 1 extends between a first end 3 and a second end 4 as a hollow body along an axis 5 and is formed by a wall 6, which encloses the axis 5 between the ends 3, 4 along a circumferential direction 7 and forms an inner space 8. The wall 6 is formed at least by a plurality of pleats 9, 10 arranged next to one another along the axis 5, which have diameters 11, 13, 15 that vary along the axis 5, extend transversely to the axis 5 and are enclosed by the wall 6. Each pleat 9, 10 extends along the axis 5 starting from a first smallest diameter 11 via a first flank 12 to a first largest diameter 13 and via a second flank 14 to a second smallest diameter 15.

In the extended (initial) state of the bellows 1, the smallest and largest diameters 11, 13, 15 extend parallel to each other. The smallest and largest diameters 11, 13, 15 and the ends 3, 4 are arranged coaxially to one another.

The axis 5 extends in a straight line, but can for example also be at least partially curved or inclined (see FIGS. 2 and 4).

Apart from the open end faces at the ends 3, 4, the wall 6 is closed, so that the bellows 1 forms an otherwise completely enclosed hollow body.

A diameter 11, 13, 15 of the respective pleat 9, 10 extending transversely to the axis 5 and enclosed or formed by the wall 6 changes essentially continuously along the axis 5. The bellows 1 is rotationally symmetrical.

In the side view of the bellows 1, i.e. in the view transverse to the axis 5, a zigzag or sawtooth-like course of the wall 6 of the bellows 1 results. Along the zigzag or sawtooth-like course, the smallest diameters 11, 15 each form the local minima of the course of the wall 6 and the largest diameters 13 form the local maxima.

FIG. 2 shows a joint arrangement 2 in an articulated first state. FIG. 3 shows the joint arrangement 2 according to FIG. 2 in an extended state. FIG. 4 shows the joint arrangement 2 according to FIGS. 2 and 3 in an articulated second state. FIGS. 2 to 4 are described together below. Reference is made to the description of FIG. 1.

Each of FIGS. 2 to 4 shows a view of the joint arrangement 2 at the top and a detail of the respective figure at the bottom. In each case, the bellows 1, which is attached by a first end 3 to an outer joint part 22 and by a second end 4 to a shaft 32, is shown in various states.

It has been observed in tests that when the ends 3, 4 are not arranged coaxially (see FIGS. 2 and 4) and when the bellows 1 is warm, most of a lubricant 34 present in the interior 8 is pressed out of the pleat 9, 10 (on the side of the axis 5 on which the pleats 9, 10 are pressed together and the usually flat flanks 12, 14 contact each other and form contact surfaces) when the rotation of the bellows 1 has ended.

The very thin film of lubricant remaining between the pressed-together flanks 12, 14 acts like an adhesive. For example, it compensates for the surface discontinuities (non-flat surfaces) of the flanks 12, 14 and thus causes strong adhesion effects between the pressed-together pleats 9, 10. The known pleats 9, 10 with flat surfaces 19 of the flanks 12, 14 have particularly large contact surfaces (see FIG. 2). The adhesion effects are particularly present at cold ambient temperatures (and for example under cold start conditions), especially when the lubricant 34 is in a frozen state.

With the subsequent start of rotation of the bellows 1 (for example with frozen lubricant 34), the flanks 12, 14 are forced to separate against the adhesion resistance of the adhesion effect described above (and thus open the pleat 9, 10). The delayed opening of the glued or adhesively bonded areas of the pleats 9, 10 creates an additional load on other areas, which in turn can fail.

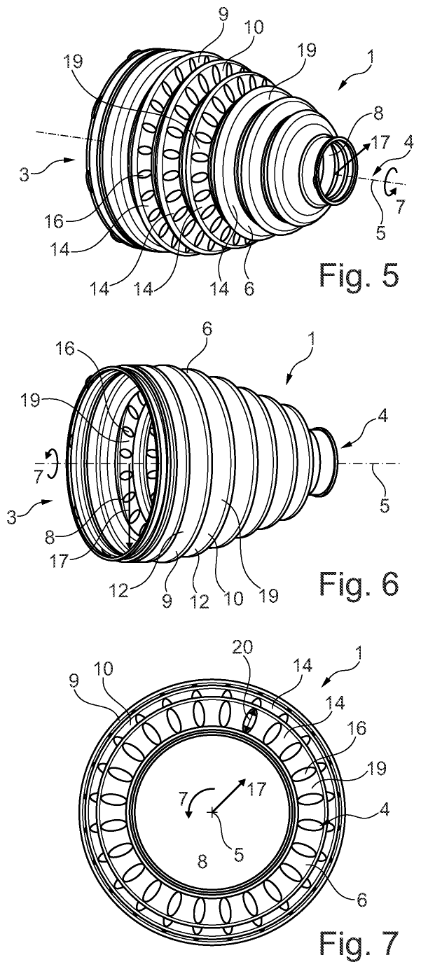

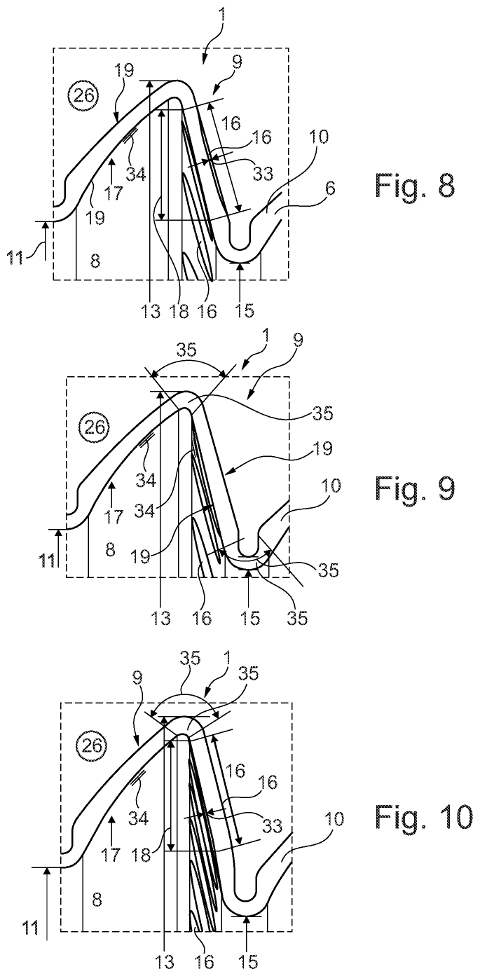

FIG. 5 shows a bellows 1 in a first perspective view. FIG. 6 shows the bellows 1 according to FIG. 5 in a second perspective view. FIG. 7 shows the bellows 1 according to FIGS. 5 and 6 in a view along the axis 5. FIG. 8 shows a first detail of the bellows 1 according to FIGS. 5 to 7. FIG. 9 shows a second detail of the bellows 1 according to FIGS. 5 to 7. FIG. 10 shows a third detail of the bellows 1 according to FIGS. 5 to 7. FIGS. 5 to 10 are described together in the following. Reference is made to the explanations of FIGS. 1 to 4.

The bellows 1 extends between a first end 3 and a second end 4 as a hollow body along an axis 5 and is formed by a wall 6, which encloses the axis 5 between the ends 3, 4 along a circumferential direction 7 and forms an interior 8. The wall 6 is formed at least by a plurality of pleats 9, 10 arranged next to one another along the axis 5. Each pleat 9, 10 extends along the axis 5 starting from a first smallest diameter 11 via a first flank 12 to a first largest diameter 13 and via a second flank 14 to a second smallest diameter 15.

In the case of a plurality of pleats 9, 10, a second flank 14 has a plurality of structures 16 distributed along the circumferential direction 7, each structure 16 being formed by an elevation enlarging the inner space 8 (see FIG. 10) or by a depression reducing the inner space 8 (see FIG. 8).

The pleats 9, 10 and structures 16 are designed or configured in such a way that when the pleats 9, 10 are in contact with one another, the structures 16 are elastically deformable and a contact surface in the inner space 8 between the flanks 12, 14 of a pleat 9, 10 is thereby enlarged (namely by the surface of one flank 12, 14 forming the structure 16 coming into contact with a surface of the other flank 14, 12).

The terms elevation and depression each denote the deviation from a flat shape of a (flat) surface 19 of the respective flank 12, 14. The flanks 12, 14 extend between the respective smallest diameter 11, 15 and the largest diameter 13 and along the circumferential direction 7 around the axis 5 and—apart from the structures 16—have a flat surface 19 or a surface with a flat shape. The structure 16 is distinguished from the flat surface 19 by a non-continuous transition of the surface (see FIGS. 5 to 10).

The wall 6 has a constant wall thickness at least in the area of the structures 16 and in the area of the flanks 12, 14, so that, for example, the elevation enlarging the inner space 8 forms a depression on the side of the second flank 14 facing the inner space 8 (see FIG. 10). Conversely, the depression that reduces the size of the inner space 8 forms an elevation on the side of the second flank 14 facing the inner space 8.

A maximum deviation 33 of the elevation or depression from an imaginary flat surface 19 is approx. 25% of the wall thickness of the second flank 14 in this area.

The shape of the flanks 12, 14 is designed or configured in such a way that all the necessary characteristics of the usual function are retained. However, the second flanks 14 have structures 16 which interrupt the large, continuous contact surfaces (with flat surfaces 19 of pleats 9, 10). The structures 16 are designed or configured in such a way that they deform elastically (back to a flat shape) when the flanks 12, 14 are pressed together. This behavior (i.e. the shape and elastic deformation when pressed together) facilitates the opening or separation of the flanks 12, 14, which form the contact surfaces with each other, in at least two ways:
1. When the flanks 12, 14 are pressed together, the lubricant 34 present between the flanks 12, 14 is displaced at least from the area of the structures 16, because the surface pressure is locally higher there. The contact surface, which transmits the adhesive forces between the pleats 9, 10 or the flanks 12, 14, is reduced by the structures 16 (i.e. the elevation or depression). This reduces the overall adhesion and facilitates the separation of the flanks 12, 14 or the opening of the pleats 9, 10.
2. The elastic energy stored in the flattening deformation of the structures 16 generates forces that support the separation of the flanks 12, 14 or the opening of the pleats 9, 10.

With two pleats 9, 10 arranged adjacent to each other along the axis 5, only one of the two opposing flanks 12, 14 (here the two flanks 14) has the structures 16. For example, this allows the structures 16 to be supported on the first flank 12 of the other pleat 10, 9 when the pleats 9, 10 are pressed together, thereby allowing them to deform back.

Alternatively (not shown here), in the case of two pleats 9, 10 arranged adjacent to each other along the axis 5, the opposite flanks 12, 14 each have elevations (i.e. structures 16 enlarging the inner space 8). For example, this also enables the structures 16 to be supported on the flank 12, 14 just formed or on the elevation of the other pleat 9, 10 when the pleats 9, 10 are pressed together and thus to be able to deform back.

Alternatively (not shown here), the opposing flanks 12, 14 of a pleat 9, 10 each have depressions (i.e. structures 16 that reduce the inner space 8). For example, this also enables the structures 16 of one flank 12, 14 to be supported on the flank 12, 14 just formed or on the depression of the other flank 12, 14 when the pleats 9, 10 are pressed together and thus to be able to deform back.

The respective structure 16 extends in a radial direction 17 transverse to the axis 5 over a height 18, whereby the following applies:

height/[(largest diameter of the flank−smallest diameter of the flank)/2]≥0.6
(see FIGS. 8 and 10).

For example, this ratio, i.e. the term

height/[(largest diameter−smallest diameter)/2]
is less than 0.95 because the structure 16 is arranged outside the respective reversal area 35 (i.e. outside the transition between two adjacent flanks 12, 14 (see FIGS. 8 and 10).

The structures 16 therefore extend over a larger part of the respective flank 12, 14, so that the largest possible elastically deformable areas and thus the smallest possible flat contact surfaces are present.

The second flank 14 has a flat surface 19 between the structures 16 and along the circumferential direction 7. The first flank 12 has flat surfaces 19 along the circumferential direction 7 and between the reversal areas 35.

The structures 16 on the second flank 14 each have a round, elliptical shape. The largest shape diameter 20 of the elliptical shape extends at least in the radial direction 17. The smallest shape diameter extends recognizably in the circumferential direction 7.

For example, all structures 16 arranged on a flank 12, 14 are designed or configured either as an elevation (according to FIG. 10) or as a depression (according to FIG. 8). Alternatively or additionally, the structures 16 arranged on a flank 12, 14 are alternately designed or configured along the circumferential direction 7 as an elevation (according to FIG. 10) and as a depression (according to FIG. 8).

It can be seen that the diameters 11, 13, 15 of the pleats 9, 10 decrease successively from the first end 3 and towards the second end 4.

### LIST OF REFERENCE SIGNS

1 bellows
2 joint arrangement
3 first end
4 second end
5 axis
6 wall
7 circumferential direction
8 inner space
9 first pleat
10 second pleat
11 first smallest diameter
12 first flank
13 first largest diameter
14 second flank
15 second smallest diameter
16 structure
17 radial direction
18 height
19 flat surface
20 largest shape diameter
21 joint
22 outer joint part
23 cavity
24 inner joint part
25 rolling body
26 surrounding area
27 motor vehicle
28 drive unit
29 wheel
30 circlip
31 journal
32 shaft
33 deviation
34 lubricant
35 reversal area

1.-13. (canceled)

14. A bellows for a joint arrangement, wherein the bellows extends between a first end and a second end as a hollow body along an axis, comprising:
a wall that encloses the axis between the ends along a circumferential direction and forms an inner space;
wherein the wall is formed at least by a plurality of pleats arranged side by side along the axis;
wherein each pleat extends along the axis starting from a first smallest diameter via a first flank to a first largest diameter and via a second flank to a second smallest diameter, and a flank of at least one pleat has a plurality of structures distributed along the circumferential direction, wherein each structure is formed by an elevation enlarging the inner space or by a depression reducing the inner space;
wherein the pleats and structures are configured such that when the pleats lie against each other, the structures are elastically deformable and a contact surface between the flanks of one pleat, present in the inner space, is thereby enlarged.

15. The bellows of claim 14, wherein, in the case of two pleats arranged adjacent to one another along the axis, only one of two opposing flanks has the structures.

16. The bellows of claim 14, wherein the respective structure extends in a radial direction transverse to the axis over a height, wherein
height/[(largest diameter−smallest diameter)/2]≥0.6.

17. The bellows of claim 14, wherein, between the structures and along the circumferential direction, the flank has a flat surface.

18. The bellows of claim 14, wherein the structures on the flank each have a curved shape.

19. The bellows of claim 16, wherein the curved shape is an elliptical shape whose largest shape diameter extends at least in the radial direction.

20. The bellows of claim 14, wherein all structures arranged on a flank are designed either as an elevation or as a depression.

21. The bellows of claim 14, wherein the structures arranged on a flank are designed alternately as an elevation and as a depression along the circumferential direction.

22. The bellows of claim 14, wherein the diameters of the pleats decrease successively starting from the first end and towards the second end, wherein the structures are arranged exclusively on the second flanks of the pleats pointing towards the second end.

23. The bellows of claim 14, wherein all pleats of the bellows have the structures.

24. A joint arrangement, comprising:
a bellows that extends between a first end and a second end as a hollow body along an axis, the bellows including:
a wall that encloses the axis between the ends along a circumferential direction and forms an inner space;
wherein the wall is formed at least by a plurality of pleats arranged side by side along the axis;
wherein each pleat extends along the axis starting from a first smallest diameter via a first flank to a first largest diameter and via a second flank to a second smallest diameter, and a flank of at least one pleat has a plurality of structures distributed along the circumferential direction, wherein each structure is formed by an elevation enlarging the inner space or by a depression reducing the inner space;
wherein the pleats and structures are configured such that when the pleats lie against each other, the structures are elastically deformable and a contact surface between the flanks of one pleat, present in the inner space, is thereby enlarged; and
a joint that includes an outer joint part with a cavity, an inner joint part, and a plurality of rolling bodies arranged between the outer joint part and the inner joint part, wherein the inner joint part is pivotably arranged in the cavity; wherein the bellows encloses the cavity with respect to a surrounding area of the joint.

25. A motor vehicle, comprising:
a bellows that extends between a first end and a second end as a hollow body along an axis, the bellows including:
a wall that encloses the axis between the ends along a circumferential direction and forms an inner space;
wherein the wall is formed at least by a plurality of pleats arranged side by side along the axis;
wherein each pleat extends along the axis starting from a first smallest diameter via a first flank to a first largest diameter and via a second flank to a second smallest diameter, and a flank of at least one pleat has a plurality of structures distributed along the circumferential direction, wherein each structure is formed by an elevation enlarging the inner space or by a depression reducing the inner space;
wherein the pleats and structures are configured such that when the pleats lie against each other, the structures are elastically deformable and a contact surface between the flanks of one pleat, present in the inner space, is thereby enlarged.

26. The motor vehicle of claim 25, further comprising:
a joint that includes an outer joint part with a cavity, an inner joint part, and a plurality of rolling bodies arranged between the outer joint part and the inner joint part, wherein the inner joint part is pivotably arranged in the cavity; wherein the bellows encloses the cavity with respect to a surrounding area of the joint.
